(19) United States
(12) Patent Application Publication
(10) Pub. No.: US 2001/0039136 A1
(43) Pub. Date: Nov. 8, 2001

(54) Fast-coupling connector for acoustic headsets

(75) Inventors: Giuseppe Vicamini, Milano (IT); Bruno Ceravolo, Milano (IT)

Correspondence Address: BRINKS HOFER GILSON & LIONE, P.O. BOX 10395, CHICAGO, IL, 60610, US

(73) Assignee: SILICOMP SpA.

(21) Appl. No.: 09/803,162

(22) Filed: Mar. 9, 2001

(30) Foreign Application Priority Data
May 5, 2000 (EP) 00830329.9

(51) Int. Cl. H01R 13/28; H01R 25/00

(52) U.S. Cl. 439/292; 439/284

(57) ABSTRACT

An electrical connector comprising two identical connector elements (6, 7) for connection of at least two electrical cables (5, 8) carrying respective conductor wires (13) connected to respective electrical contacts (12, 12′) provided inside the shell of each connector element so that, when the two connector elements are coupled, the electrical contacts are in contact with each other, wherein each of said electrical contacts (12, 12′) provides first snap-coupling means able to bring about a first snap connection during coupling of said connector elements (6, 7) and each shell of said connector elements (6, 7) provides second snap-coupling means able to bring about a second snap coupling to allow mechanical retention of said coupled connector elements.

### DESCRIPTION

The present invention refers to a fast-coupling connector for acoustic headsets and in particular for telephone headsets.

As is known, telephone headsets comprise an earpiece assembly which has an electroacoustic transducer to convert the electrical signal to an acoustic signal and a microphone assembly which has an acoustic-electrical transducer to convert an acoustic signal to an electrical signal.

The earpiece assembly and the microphone assembly are connected to respective voice conductors which are grouped in a cable or sheath which must be connected to a telephone set so that the voice conductors of the headset are connected to the respective voice conductors of the telephone set.

In order to achieve this, the telephone cable that connects the telephone transmitter to the telephone set is replaced by a special telephone cable which provides a standard telephone connector at one end for connection to the telephone set and a connector element at the other end able to engage with a complementary connector element provided at the end of the cable leaving the headset.

The connectors that connect the headset cable to the telephone cable according to the prior art have various drawbacks. In fact the coupling between the connector element of the headset cable and the connector element of the telephone cable is very complex and requires several operations by the user.

Moreover, the connectors according to the prior art generally provide two connector elements that are substantially different from each other, that is to say a male connector element and a female connector element. This results in a greater complexity of the connector and consequently higher manufacturing costs.

Plantronics U.S. Pat. No. 5,259,780 shows a fast-coupling connector of the hermaphroditic type, that is with two identical connector elements for connection. In this solution the electrical contacts are fixed to the connector element by means of a contact support, which houses the said contacts. The contacts are fixed to the contact support by means of bayonet insertion, so as to have a certain clearance that allows them to be inclined during contact. When the two connector elements are coupled, there is a sliding contact between the respective contacts and in this manner a single continuous area of contact is created between the two contacts.

This type of connector has various drawbacks. Fist of all the provision of the contact support implies a further structural complexity and therefore additional costs.

Furthermore, the fact that the contacts have a single continuous area of contact during coupling implies problems in receiving and transmitting the signal. In fact movements of the connector can cause a momentary loss of contact or rubbing between the contacts and thus the so-called discharge/flash-over effect which leads to a deterioration in the quality of the signal received and transmitted.

Lastly, one of the main drawbacks of the connector according to U.S. Pat. No. 5,259,780 is due to the fact that the mechanical hold or retention between the two connector elements is limited in time. In fact said hold is due solely to the snap fixing that takes place between he shells of the connector elements, and after a certain number of snaps wear occurs on the means for snap engagement and thus the mechanical hold between the connector elements is lost.

An object of the present invention is to provide a fast-coupling connector for telephone headsets that allows simple and fast coupling of the two connector elements.

Another object of the present invention is to provide such a connector that is economical, simple to make and reliable from an electrical point of view.

Yet another object of the invention is to provide such a connector that ensures a perfect electrical contact between the contacts and an excellent mechanical hold between the two elements of the connector.

These objects are achieved according to the invention with the characteristics listed in appended independent claim 1.

Advantageous embodiments of the invention are apparent from the dependent claims.

The fast-coupling connector according to the invention comprises two substantially identical connector elements. Each connector element consists of an upper half-shell and a lower half-shell made of plastic and having ergonomic geometrical shapes for easy gripping, which facilitates connection/disconnection.

Special seats for the electrical contacts are provided in the lower half-shell so that during assembly the electrical contacts can be positioned directly in said seats, without any need to provide contact supports.

The electrical contacts have protrusions at their tips. In this manner, when coupling takes place between the two elements of the connector, the respective contacts bend and there is a snap during sliding of the protrusions of the matching contacts one upon the other. Once the point of contact of the protrusions has been passed, two contacts have two separate points of contact. Moreover the contacts have a particular thin plate structure to ensure self-cleaning thereof during each coupling/uncoupling of the connector.

The voice conductors carried by the cable can be connected extremely easily by crimping or welding to the electrical contacts.

Each connector element provides a mechanical snap fastening to ensure good coupling between the two elements of the connector, avoiding accidental uncoupling.

The peculiar characteristic of the connector according to the invention consists in imposing upon the connector elements such a size as to have two snap couplings. A first coupling is provided by the elasticity of the electrical contacts and the second coupling is provided by the snap fastening system between the shells of the connector elements. This double fastening, thanks to the provision of the coupling between the electrical contacts, allows the bond or hold between the connector elements to be ensured even when the snap fastening system between the shells is completely worn out.

Moreover, during coupling two points of contact are generated between two coupled conductors. In this manner, if a point of contact between the contacts is lost because of the movement of the connector, the other point of contact always remains, thus ensuring continuity of the contact and thus the good quality of the signal transmitted and received.

Further characteristics of the invention will be made clearer by the detailed description that follows, referring to a purely exemplary and therefore non-limiting embodiment thereof, illustrated in the appended drawings in which:

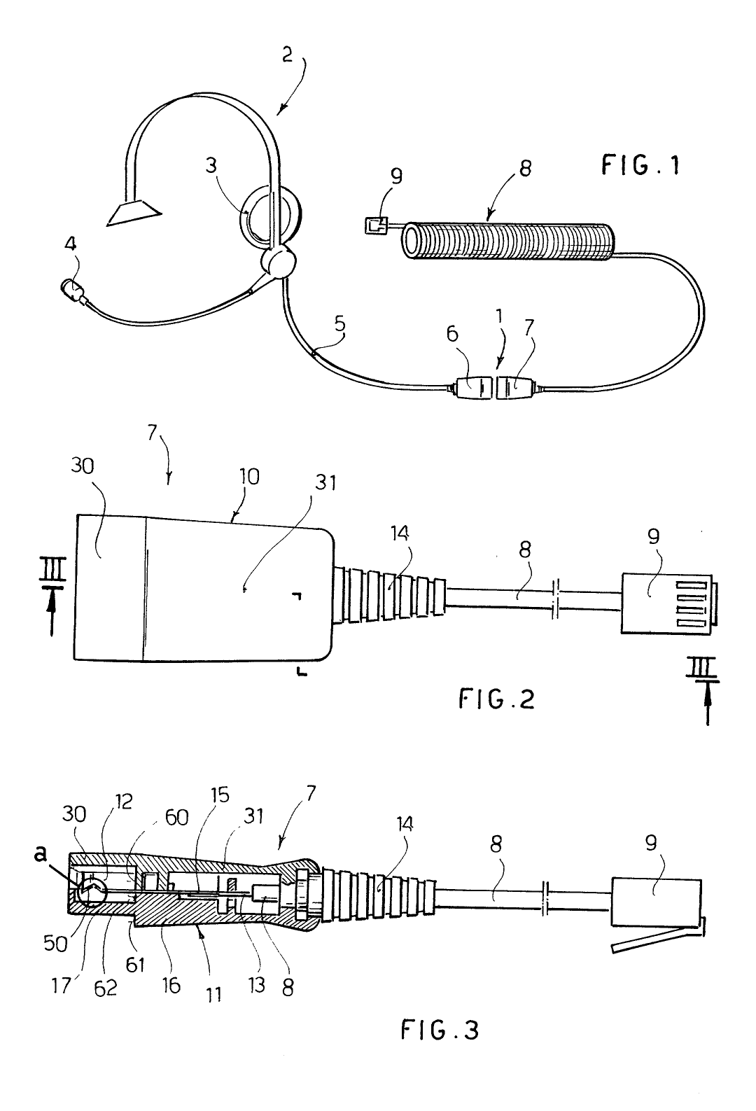

FIG. 1 is a diagrammatic perspective view, showing the connector according to the invention used for connection of a headset cable and a telephone cable;

FIG. 2 is a top plan view of a connector element connected to the telephone cable;

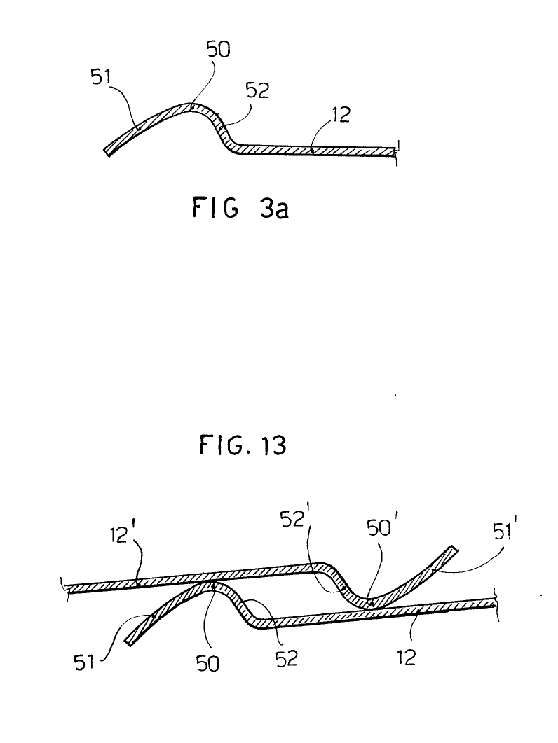

FIG. 3 is a longitudinal sectional view taken along the plane of section III-III in FIG. 2;

FIG. 3a is an enlarged view of the detail enclosed in the circle a of FIG. 3, illustrating a protrusion of an electrical contact;

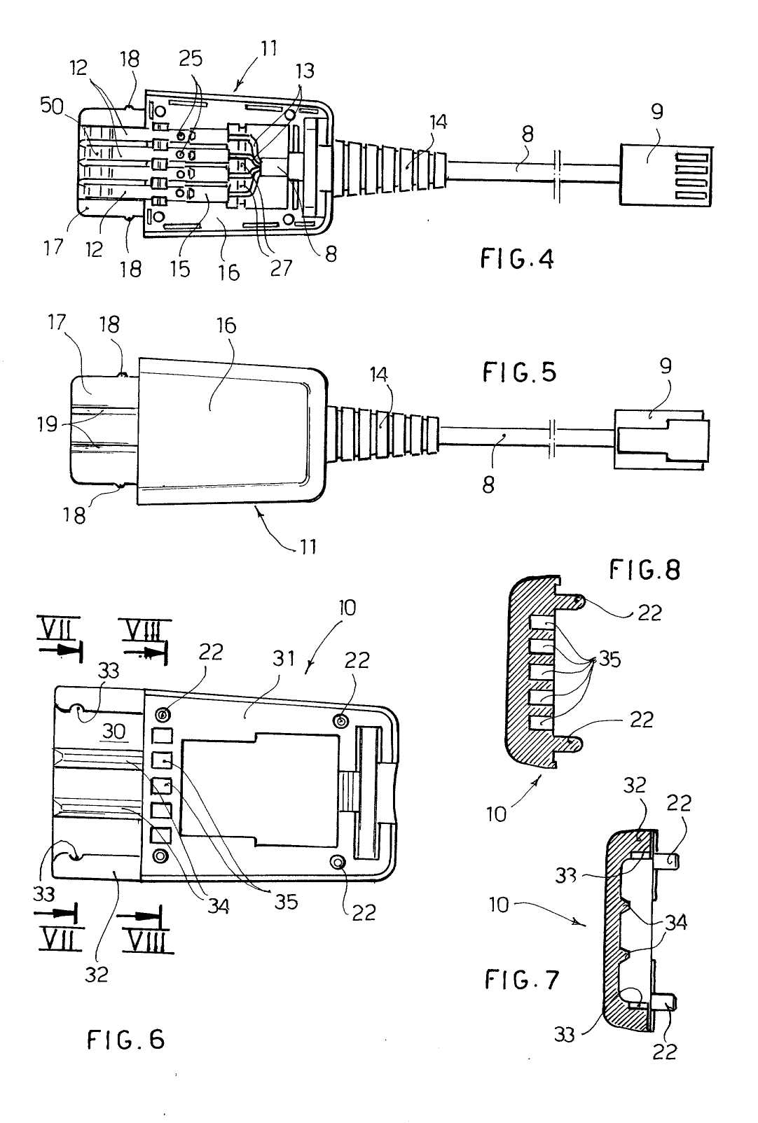

FIG. 4 is a top plan view of the connector element in FIG. 1, connected to the telephone cable, in which the upper half-shell has been removed;

FIG. 5 is a bottom plan view of the lower half-shell in FIG. 4;

FIG. 6 is an enlarged plan view, illustrating the inner surface of the upper half-shell of the connector element in FIGS. 2 and 3;

FIG. 7 is a cross sectional view along the plane of section VII-VII in FIG. 6;

FIG. 8 is a cross sectional view along the plane of section VIII-VIII in FIG. 6;

FIG. 9 is an enlarged top plan view illustrating the inner surface of the lower half-shell;

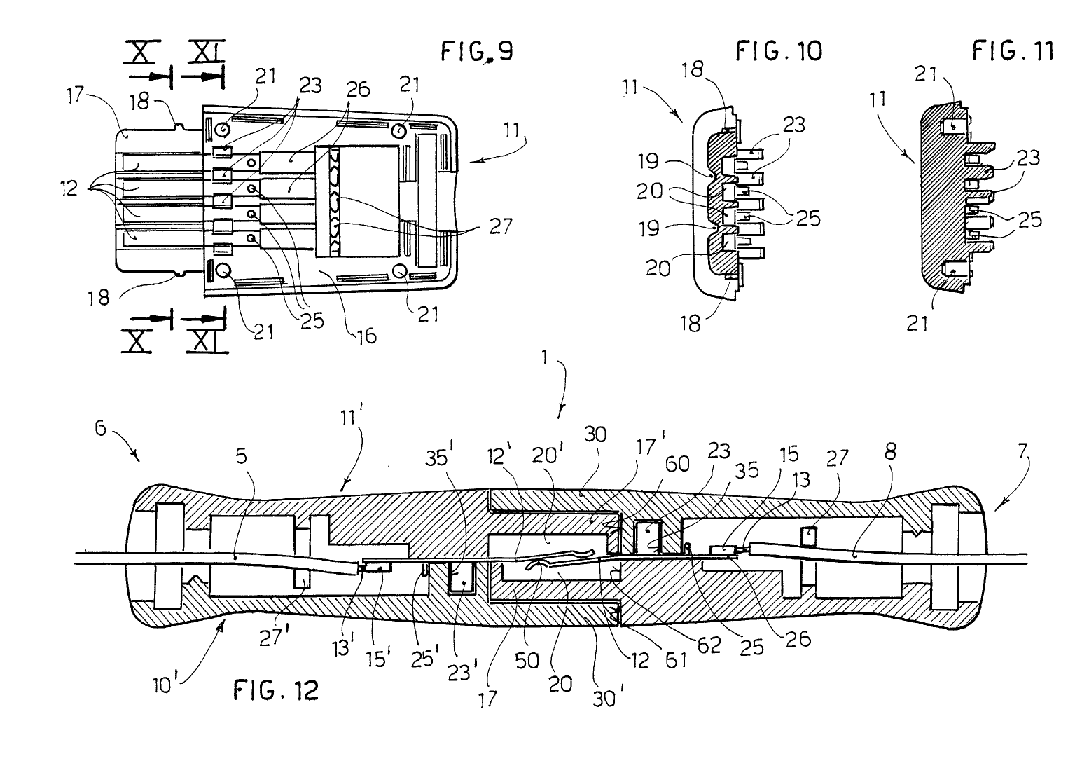

FIG. 10 is a cross sectional view along the plane of section X-X in FIG. 9;

FIG. 11 is a cross sectional view along the plane of section XI-XI in FIG. 9;

FIG. 12 is a longitudinal sectional view showing the connection between two connector elements of the connector according to the invention.

FIG. 13 is a broken off sectional view showing two electrical contacts of the connector according to the invention, in the position of contact.

The fast-coupling connector, denoted as a whole by reference numeral 1, will be described with the aid of the figures.

FIG. 1 shows a telephone-type audio headset 2, which comprises an earpiece assembly 3 and a microphone assembly 4. The earpiece assembly 3 is generally connected to two voice conductors for reception of the audio signal and the microphone assembly 4 is connected to two voice conductors for transmission of the audio signal.

The four voice conductors are grouped inside a cable 5 connected to the headset 2. Connected to the free end of the cable 5 of the headset is a connector element 6 intended to couple with a complementary connector element 7 connected to a telephone cable 8 which carries at its other end a telephone-type connector element 9 intended to be connected to a telephone apparatus.

The two connector elements 6 and 7 form the connector 1 according to the invention. The two connector elements 6 and 7 are perfectly identical and have the same structure; however, according to their positioning, they prove to be specular to ensure coupling thereof.

With reference to FIGS. 2, 3 and 5, the connector element 7 comprises an upper half-shell 10 and a lower half-shell 11. The half-shells 10 and 11 are made of plastic, by means of moulding; their outer surface has an ergonomic shape to facilitate gripping by the user.

The upper half-shell 10 has a body part 31 and a coupling part 30 which protrudes forward from the body part 31. The coupling part 30 has the same width as the body part 31 and is separated therefrom by a wall 60 which protrudes inwards.

The lower half-shell 11 also has a body part 16 and a coupling part 17 which protrudes forward from the body part 16. The width and thickness of the coupling part 17 are smaller than the width and thickness of the body part 16, and an outer step and an inner step 62 are provided between the coupling part 17 and the body part 16.

As shown in FIG. 4, the lower half-shell 11 carries four electrical contacts 12, with a substantially flattened plate shape. The electrical contacts 12 are fixed at 25 to the body part 16, so as to protrude onto the coupling part 17 and be able to bend thereon.

As shown in FIGS. 3 and 3a, each contact 12 has at its end, on the coupling part 17, a protrusion 50 having a substantially arched or cusp shape, with its hollow facing downward. The protrusion 50 is preferably cusp-shaped with a forward profile 51, facing toward the end of the contact, having a slight slope and a rearward profile 52, facing toward the body part 16, having a steeper slope. The forward profile 51 is slightly arched so as to form a cam surface, whilst the rearward profile 52 is more rectilinear so as to form an abutment surface. The contacts 12 are made from highly flexible conductive material, such as nickel silver, or beryllium copper, with gilding (selective) in the contact areas.

Each contact 12 is connected, by means of crimping or welding 15, to a respective conductor wire (voice conductor) 13 coming from the telephone cable 8 which extends through a sheath 14 of rubber or other soft material, disposed in the rear end of the connector element 7, sandwiched between the half-shells 11 and 10.

In the side walls of the coupling part 17 of the lower half-shell 11 ribs 18 are provided which are intended to engage, in a coupling relationship, with complementary grooves provided in the complementary connector element 6 for snap fastening.

As shown in FIGS. 5 and 10, on the outer surface of the coupling part 17 of the lower half-shell 11 two grooved guides 19 are formed, able to engage, in a sliding relationship, with complementary tracks provided in the complementary connector element 6, in order to have perfect centring of the two connector elements.

Again with reference to FIG. 10, four elongated seats 20 are formed in the inner surface of the coupling part 17 of the lower half-shell 11, in a position below the thin plate contacts 12, so as to allow bending of the contacts 12 inside said seats 20.

As shown in FIGS. 9 and 11, in the inward facing surface of the body part 16 of the lower half-shell 11 four blind holes 21 are provided, able to receive respective mounting pins 22 (FIGS. 6-8) provided in the inner surface of the body part 31 of the upper half-shell 10, to allow assembly of the two half-shells. Assembly of the two half-shells 10 and 11 preferably takes place by means of ultrasound welding, to speed up assembly operations and ensure a certain resistance to tampering.

In the inner surface of the body part 16 of the half-shell 11, in proximity to the borderline with the coupling part 17, five spacer pins 23 are provided, spaced apart from each other so as to create four gaps in which the four thin plate contacts 12 are accommodated. The function of the spacer pins 23 is to keep the contacts 12 separate and facilitate mounting thereof

The thin plate contacts 12 terminate in pad or bump contacts 26 for welding or crimping with the strands of the voice conductors 13.

As shown in FIGS. 9 and 4, five spacer pins 27 are provided after the bump contacts 26, arranged so as to form four gaps for passage of the four conductors 13, in order to keep the conductor wires 13 spaced apart and secured.

With reference to FIGS. 6-8, the coupling part 30 of the upper half-shell 10 provides two inward facing side walls 32. In the inner surface of the two side walls 32, two slits 33 are provided, able to receive corresponding ribs of the complementary connector element 6, similar to the ribs 18 described previously.

In the inward facing surface of the coupling part 30 of the upper half-shell 10 two longitudinal tracks 34 are provided, arranged parallel to each other and able to engage, in a sliding coupling relationship, in grooved guides provided in the complementary connector element 6, similar to the grooved guides 19 described previously.

In the inward facing surface of the body part 31 of the upper half-shell 10 five seats 35 are formed, able to accommodate the five spacer pins 23 provided in the lower half-shell 11.

Once the contacts 12 have been positioned in the lower half-shell 11 and the conductor wires 13 have been fixed to the contacts 12, the upper half-shell 10 is positioned on the lower half-shell 11 and the energy directors (shell ribs) are fused by ultrasound welding, allowing the two half-shells to be coupled by welding. Fusion of the energy directors of the upper half-shell 10 blocks the contacts 12, making them integral with the half-shells 10 and 11, as if the contacts were inserted with still molten material.

Coupling between the connector element 7 and the connector element 6 will now be described with reference to FIG. 12.

The connector element 6 is perfectly identical to the connector element 7. For greater clarity the various parts of the connector element 6 are indicated by the same numbers used to indicate the parts of the connector element 7, followed by a prime.

As shown in FIG. 12, the connector element 6 is rotated 180° with respect to the connector element 7, that is to say the upper half-shell 10′ faces downward and the lower half-shell 11′ faces upward. In this configuration, when the two connector elements 6 and 7 are coupled, the protrusions 50 and 50′ of the respective contacts 12 and 12′ come into sliding contact along their forward profiles 51, 51′, which act as cams. Consequently the contacts 12 are inclined downward in the respective seats 20 of the lower half-shell 11 and the contacts 12′ are inclined upward in the respective seats 20′ of the lower half-shell 11′.

When the point of contact between the protrusions 50 and 50′ of the contacts 12, 12′ is passed a first snap is generated and thus the two connector elements 6 and 7 can be brought closer together. In any case, in this situation the electrical contact is ensured since the protrusions 50 of the contacts 12 touch the flat parts of the respective contacts 12′ and the protrusions 50′ of the contacts 12′ touch the flat parts of the respective contacts 12.

During coupling, centring between the two connector elements 6 and 7 is ensured by the fact that the tracks 34 (FIG. 6) of the connector element 7 and the tracks (not shown) of the connector element 6 slide respectively in the grooved guides (not shown) of the connector element 6 and in the grooved guides 19 (FIG. 5) of the connector element 7.

After the snap coupling between the contacts 12 and 12′ a second snap coupling is generated between the shells of the two connector elements 6 an 7. This second snap coupling between the two connector elements 6 and 7 is ensured by the fact that the lateral ribs 18 (FIG. 5) of the connector element 7 and the lateral ribs (not shown) of the connector element 6 engage respectively in the lateral seats (not shown) of the connector element 6 and the lateral seats 33 (FIG. 6) of the connector element 7.

It should be noted that in the position of coupling of the two connector elements 6 and 7, shown in FIGS. 12 and 13, there are two separate points of contact between the two contacts 12, 12′ and the contact 12 is bent slightly downward, whilst the contact 12′ is bent slightly upward. In this manner, if the point of contact is momentarily lost because of shifting of the connector 1, the electrical contact is always ensured by the other point of contact and thus the quality of signal transmission is guaranteed.

It should further be noted that after a large number of connections, a certain wear is generated on the lateral ribs 18 and the lateral seats 33 which ensure snap coupling of the connector shells. Consequently, the mechanical hold between the two connector shells 6 and 7 can be lost. However, the connector according to the invention can continue to be used, since the hold between the two connector elements 6 and 7 is ensured by the rearward profiles 52, 52′ of the protruding parts 50, 50′ of the contacts 12, 12′ which, coming into contact with each other, act as abutment surfaces and allow a certain retention, avoiding accidental uncoupling of the connector and at the same time ensuring the continuity of the contact.

The present description has been made with specific reference to four contacts 12, one for each sound conductor 13. It is obvious, however, that with arrangements within the reach of an expert in the field, the connector 1 according to the invention can be adapted to a different number of electrical contacts for a different number of conductor wires and can be adopted for any electrical connection between electrical devices and electrical cables which comprise conductor wires.

Numerous changes and modifications within the reach of an expert in the field can be made to the present embodiment without departing from the scope of the invention, set forth in the appended claims.

1. An electrical connector comprising two identical connector elements for connection of at least two electrical cables carrying respective conductor wires connected to respective electrical contacts provided inside the shell of each connector element so that, when the two connector elements are coupled the electrical contacts are in contact with each other, wherein each of said electrical contacts provides first snap-coupling means able to bring about a first snap coupling during coupling of said connector elements and each shell of said connector elements provides second snap-coupling means able to bring about a second snap coupling to allow mechanical retention of said coupled connector elements.

2. A connector according to claim 1, wherein after said second snap coupling between said second snap-coupling means of the shells of the connector elements, each pair of coupled electrical contacts of the two connector elements has at least two separate points of contact.

3. A connector according to claim 1, wherein said electrical contacts are in the form of a flattened thin plate and said first snap coupling means comprise a part that protrudes with respect to the plane of the thin plate.

4. A connector according to claim 2, wherein said electrical contacts are in the form of a flattened thin plate and said first snap coupling means comprise a part that protrudes with respect to the plane of the thin plate.

5. A connector according to claim 3, wherein said protruding part of the contact is substantially cusp-shaped.

6. A connector according to claim 4, wherein said protruding part of the contact is substantially cusp-shaped.

7. A connector according to claim 5, wherein said protruding part of the contact has a forward profile with a slight slope able to form a cam surface and a rearward profile with a greater slop than that of the forward profile able to form an abutment surface.

8. A connector according to claim 6, wherein said protruding part of the contact has a forward profile with a slight slope able to form a cam surface, and a rearward profile with a greater slope than that of the forward profile able to form an abutment surface.

9. A connector according to claim 1, wherein each connector element has an upper half-shell and a lower half-shell which can be assembled together, so as to enclose said electrical contacts, each half-shell comprising a body part for connection to the cable containing the conductor wires and a coupling part for coupling with the other connector element, said contacts being fixed by means of ultrasonic welding in the body part of said lower half-shell, so that they can protrude onto said coupling part of said lower half-shell.

10. A connector according to claim 9, wherein elongated seats are provided in the coupling part of the lower half-shell such as to accommodate said contacts when they bend during coupling of the connector.

11. A connector according to claim 9 wherein guide means are provided in said coupling parts of the lower and upper half-shells for centring with the coupling parts of a corresponding connector element, said guide means being tracks provided in the inward facing surface of said coupling part of said upper half-shell and grooved guides, complementary to said tracks, provided on the outward facing surface of said coupling part of said lower half-shell, so that said tracks can slide inside the grooved guides of a complementary connector element or vice versa.

12. A connector according to any one of claim 9, wherein said snap-coupling means are provided in said coupling parts of said lower and upper half-shells and comprise outer ribs of said coupling part of the lower half-shell and seats, complementary to said ribs provided in side walls of said coupling part of said upper half-shell, so that said ribs snap couple inside seats of a complementary connector element and vice versa.

13. A connector according to claim 1, wherein said two electrical cables connected to the two connector elements are a cable carrying the voice conductors of an acoustic headset, and a telephone cable which provides a connector element for connection to a telephone apparatus.

14. A connector according to claim 2, wherein said two electrical cables connected to the two connector elements are a cable carrying the voice conductors of an acoustic headset, and a telephone cable which provides a connector element for connection to a telephone apparatus.

15. A connector according to claim 9, wherein said two electrical cables connected to the two connector elements are a cable carrying the voice conductors of an acoustic headset, and a telephone cable which provides a connector element for connection to a telephone apparatus.
